(19) United States
(12) Patent Application Publication
(10) Pub. No.: US 2024/0346433 A1
(43) Pub. Date: Oct. 17, 2024

(54) INFORMATION PROCESSING APPARATUS MANAGING CONSUMABLE PRODUCT OF IMAGE FORMING APPARATUS, CONTROL METHOD, AND STORAGE MEDIUM

(71) Applicant: CANON KABUSHIKI KAISHA, Tokyo (JP)

(72) Inventor: TOMONORI HAYASHI, Chiba (JP)

(21) Appl. No.: 18/631,827

(22) Filed: Apr. 10, 2024

(30) Foreign Application Priority Data
Apr. 14, 2023 (JP) 2023-066397

(51) Int. Cl. G06Q 10/083; G06Q 10/04; H04N 1/00; H04N 1/34

(52) U.S. Cl. CPC G06Q 10/0838; G06Q 10/04; H04N 1/00832; H04N 1/346

(57) ABSTRACT

An information processing apparatus capable of executing a predetermined process for ordering a consumable product of an image forming apparatus includes one or more processors causes the information processing apparatus to calculate a predicted consumption degree of the consumable product based on a contracted plan selected by a user from among plans for using the image forming apparatus in the predetermined process, determine whether the predicted consumption degree reaches a predetermined value, and control so as to ship the consumable product to the user in a case where it is determined that the predicted consumption degree reaches the predetermined value.

### BACKGROUND

### Field of the Disclosure

The present disclosure relates to an information processing apparatus, a control method therefor, and a storage medium storing a control program therefor.

### Description of the Related Art

Subscription services for image forming apparatuses such as printers are known. A subscription service for an image forming apparatus allows a user to print at a fixed price up to the upper limit number of print pages corresponding to a plan contracted by the user during a contract period. The subscription service for the image forming apparatus enables replenishment of print sheets and replacement of a replacement part like a toner cartridge without paying an additional fee during the contract period.

The subscription service for the image forming apparatus has a great merit that the user can use the image forming apparatus without worrying about the use-up of the print sheets, the toner, etc. Therefore, a service provider needs to send consumable products, such as print sheets and toner cartridges, at an appropriate timing before the print sheets and toner are used up. In contrast, there is a known technique that calculates a predicted consumption amount of a consumable product in use of an image forming apparatus by a user on the basis of relation information indicating a relation between attribute information of the user and consumption information indicating a consumption amount of the consumable product of the image forming apparatus (see Japanese Patent Laid-Open Publication No. 2021-117877 (Counterpart of U.S. Pat. No. 20,210,232877 A1)). Further, shipping of the consumable product is controlled on the basis of the predicted consumption amount.

For example, the subscription service for the image forming apparatus provides a plurality of plans that are different in the upper limit number of print pages, and the user can change a plan according to a change in consumption behavior. For example, the user can use a plan of which the upper limit number of print pages is large in a busy month, and can change the plan to a plan of which the upper limit number of print pages is small after the busy month.

However, since the technique of the above-described publication calculates the predicted consumption amount from the actual consumption amount of the consumable product when the user has used the image forming apparatus so far, the calculation accuracy of the predicted consumption amount is lowered when the consumption behavior of the user has changed so far as described above. As a result, the consumable product cannot be shipped at an appropriate timing.

### SUMMARY

Embodiments of the present disclosure provide a mechanism by which a consumable product can be shipped at an appropriate timing.

According to an aspect of the present disclosure, an information processing apparatus capable of executing a predetermined process for ordering a consumable product of an image forming apparatus includes one or more processors causes the information processing apparatus to calculate a predicted consumption degree of the consumable product based on a contracted plan selected by a user from among plans for using the image forming apparatus in the predetermined process, determine whether the predicted consumption degree reaches a predetermined value, and control so as to ship the consumable product to the user in a case where it is determined that the predicted consumption degree reaches the predetermined value.

Further features will become apparent from the following description of exemplary embodiments with reference to the attached drawings.

### BRIEF DESCRIPTION OF THE DRAWINGS

FIG. 1 is a view illustrating an example of a configuration of a management system including a management server as an information processing apparatus according to an embodiment.

FIG. 2 is a block diagram schematically illustrating a hardware configuration of the management server in FIG. 1.

FIG. 3 is a block diagram schematically illustrating a hardware configuration of an image forming apparatus in FIG. 1.

FIG. 4A to FIG. 4D are views illustrating configurations of data stored in an HDD in FIG. 2.

FIG. 5 is a flowchart illustrating a procedure of a plan change process executed by the management server in FIG. 1.

FIG. 6 is a flowchart illustrating a procedure of a consumable product order process executed by the management server in FIG. 1.

FIG. 7 is a view illustrating a configuration of apparatus data stored in the HDD in FIG. 2.

FIG. 8 is a flowchart illustrating another procedure of the consumable product order process in FIG. 6.

### DESCRIPTION OF THE EMBODIMENTS

Hereafter, some exemplary embodiments according to the present disclosure will be described in detail by referring to the drawings.

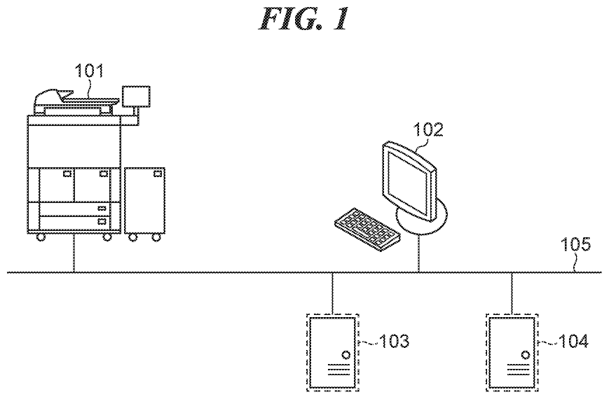

FIG. 1 is a view illustrating an example of a configuration of a management system including a management server 103 as an information processing apparatus according to the embodiment. The management system includes a plurality of image forming apparatuses, a plurality of communication apparatuses, the management server 103, and an order server 104. These are communicably connected via a network 105. In FIG. 1, only an image forming apparatus 101 among the plurality of image forming apparatuses is illustrated and only a communication apparatus 102 among the plurality of communication apparatuses is illustrated in order to simplify description. In the following description, the configuration of the plurality of image forming apparatuses will be described using the image forming apparatus 101, and the configuration of the plurality of communication apparatuses will be described using the communication apparatus 102.

The management system provides a subscription service for an image forming apparatus. This subscription service provides a plurality of plans that are different in the upper limit number of print pages. This subscription service allows printing on pages within the upper limit number of print pages corresponding to a plan contracted by a user at a fixed price during a contract period. In addition, the subscription service lends an image forming apparatus main body, replenishes print sheets, and replaces a replacement part like a toner cartridge without paying an additional fee during the contract period.

The image forming apparatus 101 can print an image on a sheet based on print data received from the communication apparatus 102. The image forming apparatus 101 can read a document by a scanner (not shown) included in the image forming apparatus 101 to generate image data of the document, and can print the image data on a sheet. The image forming apparatus 101 transmits a consumption degree of a consumable product used in the image forming process to the management server 103. The consumable products are, for example, replacement parts, such as a toner cartridge and an ink cartridge, and print sheets. In this embodiment, a count value, such as the number of times of use of the consumable product or the number of used sheets, may be transmitted to the management server 103 as the consumption degree. Further, information representing the consumption degree of the consumable product by percentage may be transmitted to the management server 103. In such a case, the consumption degree at which replenishment or replacement of the consumable product is required shall be 100%. The image forming apparatus 101 periodically transmits the consumption degree of the consumable product to the management server 103. Alternatively, the image forming apparatus 101 may transmits the consumption degree of the consumable product to the management server 103 after executing a predetermined event, such as an image forming process, in which the consumable product is used or when receiving a transmission request from the management server 103.

The management server 103 manages the consumption degree received from the image forming apparatus 101. The management server 103 can provide setting values and consumption degrees of a plurality of image forming apparatuses subjected to management to the communication apparatus 102 etc. via the network 105. For example, the user can check the consumption degrees and the setting values of the image forming apparatus 101 by viewing information displayed on a display unit (not illustrated) of the communication apparatus 102 by accessing the management server 103 from the web browser of the communication apparatus 102.

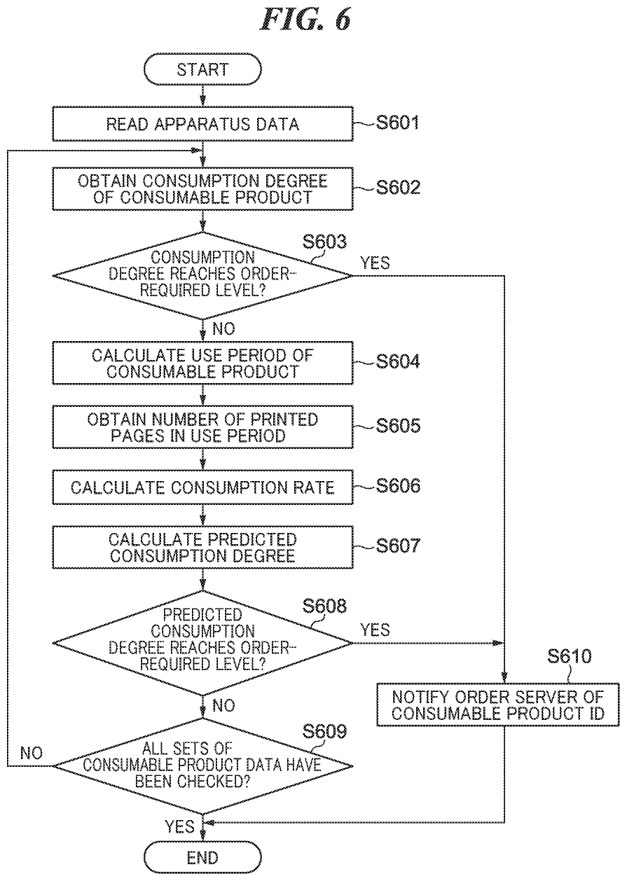

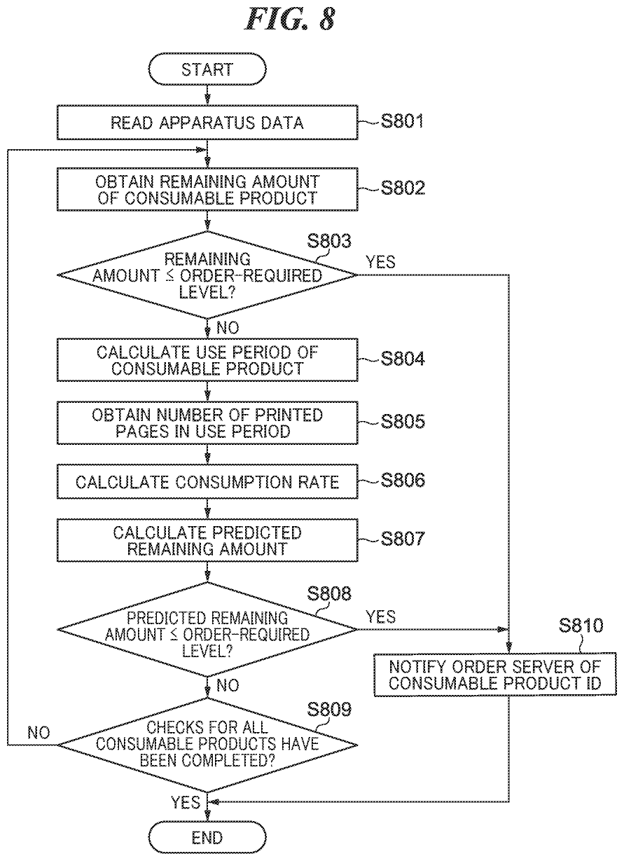

The management server 103 also manages information about the plan contracted by the user. For example, the user can check information about the contracted plan or change the plan by accessing the management server 103 from the web browser of the communication apparatus 102. Further, the management server 103 controls so as to ship a consumable product of the image forming apparatus 101 to the user by executing a consumable product order process in FIG. 6 or FIG. 8 described below.

The order server 104 performs a process for shipping a consumable product to the user based on the information received from the management server 103. Although the management server 103 and the order server 104 are separate apparatuses in this embodiment, this is not limiting. For example, the functions of the management server 103 and order server 104 may be implemented by a single server.

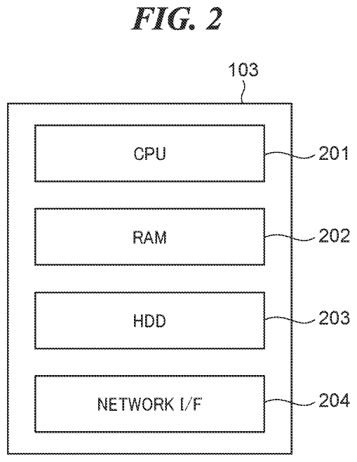

FIG. 2 is a block diagram schematically illustrating a hardware configuration of the management server 103 in FIG. 1. In FIG. 2, the management server 103 is configured by a CPU 201, a RAM 202, an HDD 203, and a network I/F 204. The CPU is an abbreviation of a Central Processing Unit. The RAM is an abbreviation of a Random Access Memory.

The CPU 201 controls the entire management server 103, and can control data transmission and reception with the RAM 202, the HDD 203, and the network I/F 204. The CPU 201 develops a control program read from the HDD 203 onto the RAM 202 and executes the control program developed on the RAM 202.

The HDD 203 stores the control program that can be executed by the CPU 201. The HDD 203 stores consumption degrees received from the image forming apparatus 101, setting values used in the image forming apparatus 101, and the like. Although the configuration in which the management server 103 includes the HDD 203 as a storage device is described in this embodiment, the storage device included in the management server 103 is not limited to an HDD and may be another storage device like an SSD.

The RAM 202 temporarily stores the control program executed by the CPU 201 and information required for executing the control program. The network I/F 204 is an interface for communicating with an external apparatus via the network 105, and transfers received information to the CPU 201 and transmits information on the RAM 202 to the external apparatus via the network 105.

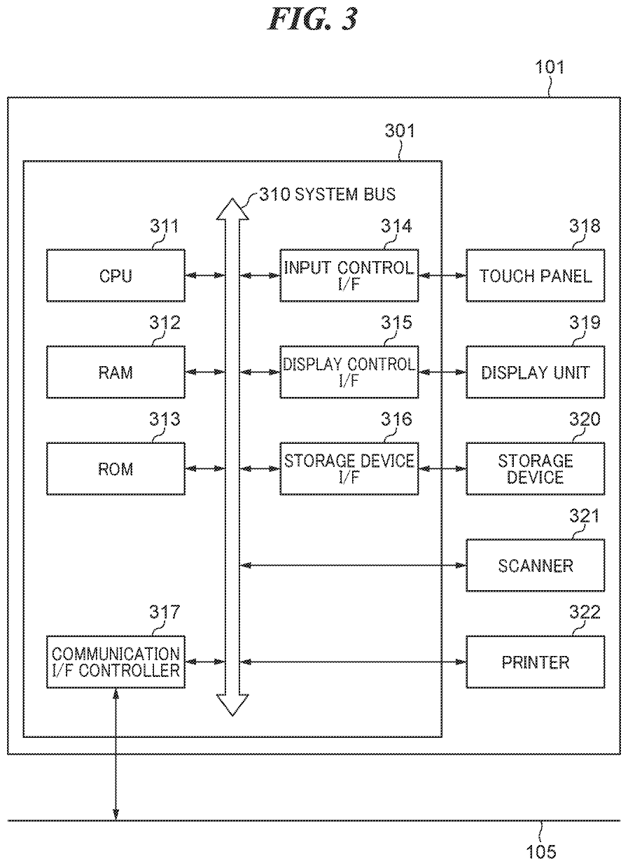

FIG. 3 is a block diagram schematically illustrating a hardware configuration of the image forming apparatus 101 in FIG. 1. In FIG. 3, the image forming apparatus 101 includes a control unit 301, a touch panel 318, a display unit 319, a storage device 320, a scanner 321, and a printer 322. The control unit 301 is connected to the touch panel 318, display unit 319, storage device 320, scanner 321, and printer 322. The control unit 301 includes a CPU 311, a RAM 312, a ROM 313, an input control I/F 314, a display control I/F 315, an storage device I/F 316, and a communication I/F controller 317. These are mutually connected via a system bus 310. The scanner 321 and printer 322 are also connected to the system bus 310. The ROM is an abbreviation of a Read Only Memory.

The CPU 311 controls the entire image forming apparatus 101. The RAM 312 is a volatile memory and is used as a main memory of the CPU 311 and a temporary storage area such as a work area. The ROM 313 is a nonvolatile memory and stores image data, other data, and various programs for operating the CPU 311. The CPU 311 controls each unit of the image forming apparatus 101 according to a program stored in the ROM 313 while using the RAM 312 as a work memory. The program for operating the CPU 311 may be stored in the storage device 320 other than the ROM 313, for example.

The input control I/F 314 is connected to the touch panel 318. The touch panel 318 is an input device configured to output coordinate information indicating a position where a user touches a planar-shaped input panel to the input control I/F 314. The input control I/F 314 is also connected to input devices for receiving user operations, such as a keyboard (not illustrated) for inputting text information and hard keys (not illustrated) for directly inputting numerical values. The input control I/F 314 generates a control signal corresponding to a content of a user's operation of an input device and outputs the control signal to the CPU 311. The CPU 311 controls each unit of the image forming apparatus 101 according to a program based on the received control signal. This enables the image forming apparatus 101 to perform an operation corresponding to the user's operation.

The display control I/F 315 is connected to the display unit 319. The display control I/F 315 outputs a display signal for displaying an image to the display unit 319. For example, the CPU 311 generates a display control signal according to the program and outputs the display control signal to the display control I/F 315. The display control I/F 315 generates a display signal based on the received display control signal. For example, the display control I/F 315 generates a display signal for displaying a graphical user interface (GUI) screen constituting a GUI. The display control I/F 315 outputs the generated display signal to the display unit 319. In this embodiment, the touch panel 318 and the display unit 319 may be integrally configured. For example, the touch panel 318 is configured such that a light transmittance is set so as not to hinder the display of the display unit 319, and is attached to an upper layer of the display surface of the display unit 319. Then, an input coordinate on the touch panel 318 is associated with a display coordinate on the display unit 319. This can configure a GUI that allows the user to directly operate a screen displayed on the display unit 319.

The storage device I/F 316 is connected with the storage unit 320. The storage device 320 is an HDD or a flash memory, for example. The CPU 311 controls to read data from the storage device 320 and write data to the storage device 320. The storage device 320 stores control programs, setting values, etc. The storage device 320 may be used instead of the RAM 312 or the ROM 313.

The CPU 311 controls the communication I/F controller 317 to communicate with various networks, such as a LAN, the Internet, a wired network, and a wireless network. For example, the communication I/F controller 317 communicates with the communication apparatus 102 connected via the network 105.

The CPU 311 controls the scanner 321 to execute a scan process. In the scan process, the scanner 321 reads a document placed on a document table or a document conveyed by an auto document feeder (ADF), and generates image data of the document. The image data generated by the scanner 321 is stored in the storage device 320 via the storage device I/F 316.

The CPU 311 controls the printer 322 to execute a print process of image data stored in the storage device 320. For example, the CPU 311 controls the printer 322 to execute the print process based on a print instruction input by the user through the touch panel 318 or print data received from the communication apparatus 102. In the print process, the printer 322 reads image data from the storage device 320, converts the image data into a printable format, and prints the converted image data on a sheet fed from a sheet feeding unit (not illustrated). The image forming apparatus 101 includes, as sheet feeding units, a sheet cassette capable of collectively feeding a large amount of sheets of a specific size such as A4 or A5, and a manual feeding unit on that a person manually places sheets.

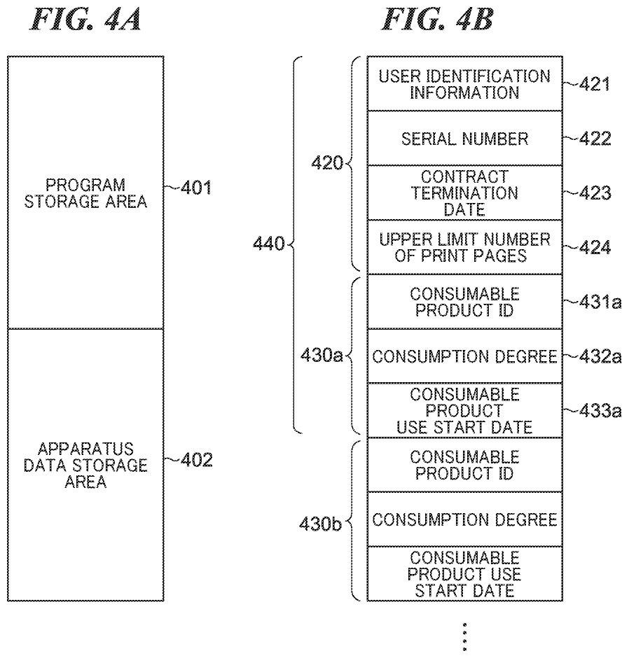

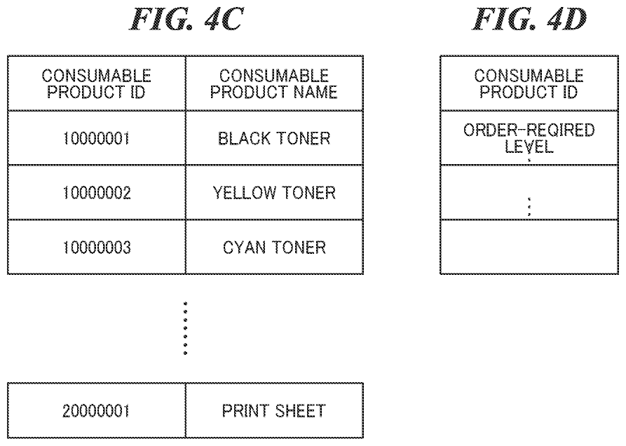

Next, a configuration of data stored in the HDD 203 of the management server 103 will be described. FIG. 4A to FIG. 4D are views illustrating the configuration of the data stored in the HDD 203 in FIG. 2. FIG. 4A is a view illustrating storage areas of the HDD 203.

The HDD 203 includes a program storage area 401 and an apparatus data storage area 402. The program storage area 401 stores a control program to be executed by the CPU 201. The CPU 201 reads the control program from the program storage area 401, develops the control program onto the RAM 202, and executes the control program developed onto the RAM 202. The apparatus data storage area 402 stores a plurality of sets of apparatus data corresponding to a plurality of image forming apparatuses to be managed. Since configurations of the sets of apparatus data are all the same, the configuration of the apparatus data 440 (FIG. 4B) about the image forming apparatus 101 will be described as an example in this embodiment.

The apparatus data 440 includes apparatus identification data 420 and a plurality of sets of consumable product data 430a, consumable product data 430b, . . . respectively corresponding to a plurality of consumable products included in the image forming apparatus 101. In FIG. 4B, the consumable product data 430a and the consumable product data 430b among n-sets of consumable product data are shown as examples.

The apparatus identification data 420 is used to identify the image forming apparatus 101, and includes user identification information 421, a serial number 422, a contract termination date 423, and an upper limit number of print pages 424. The user identification information 421 is information for identifying a user who uses the image forming apparatus 101. The serial number 422 is the number for identifying the image forming apparatus 101. The contract termination date 423 is the termination date of the subscription service contract for the image forming apparatus 101. The upper limit number of print pages 424 is the upper limit number of pages that can be printed by the image forming apparatus 101 without paying an additional fee within the contract period.

The consumable product data 430a, the consumable product data 430b, . . . are data related to consumable products of the image forming apparatus 101. The consumable product data 430a, the consumable product data 430b, . . . have the same configuration, and the configuration of the consumable product data 430a will be described below as an example.

The consumable product data 430a is configured by a consumable product ID 431a, a consumption degree 432a, and a consumable product use start date 433a. The consumable product ID 431a is the number for identifying the consumable product corresponding to the consumable product data 430a from among a plurality of consumable products included in the image forming apparatus 101. In this embodiment, as shown in FIG. 4C, names of consumable products corresponding to the consumable product IDs are managed. In this embodiment, as shown in FIG. 4D, an order-required level indicating a consumption degree at which the consumable product needs to be replenished or replaced are defined for each consumable product ID.

The consumption degree 432a is information indicating the consumption degree of the consumable product in percentage while the consumption degree of the consumable product corresponding to the consumable product data 430a that requires replenishment or replacement is set to 100%. The consumption degree 432a may not be information represented by the percentage described above as long as the information reveals the current consumption degree with respect to the consumption degree at which replenishment or replacement is required. The consumable product use start date 433a is a date on which the use of the consumable product corresponding to the consumable product data 430a is started.

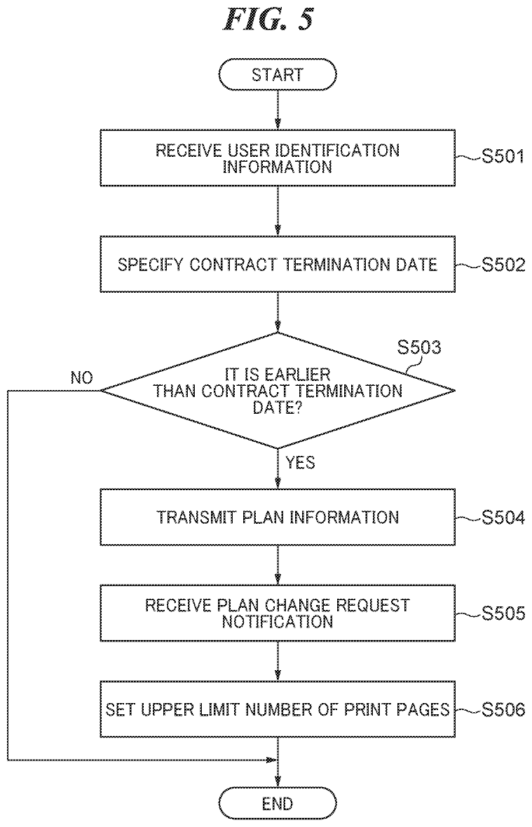

FIG. 5 is a flowchart illustrating a procedure of a plan change process executed by the management server 103 in FIG. 1. The plan change process in FIG. 5 is achieved by the CPU 201 of the management server 103 executing a control program stored in the HDD 203. The plan change process in FIG. 5 is started when a user who has made the contract for the subscription service with the service provider and uses the image forming apparatus 101 instructs the communication apparatus 102 to transmit user identification information indicating the user to the management server 103.

In FIG. 5, the CPU 201 first receives the user identification information from the communication apparatus 102 via the network I/F 204 (S (step) 501). Next, the CPU 201 obtains the apparatus data 440 corresponding to the received user identification information from among the plurality of sets of apparatus data stored in the HDD 203. The CPU 201 specifies the contract termination date of the subscription service for the image forming apparatus 101 based on the contract termination date 423 in the obtained apparatus data 440 (S502).

The CPU 201 then determines whether the current date is earlier than the contract termination date (S503). When it is determined in S503 that the current date is not earlier than the contract termination date, the plan change process is terminated. When it is determined in S503 that the current date is earlier than the contract termination date, the plan change process proceeds to S504.

In S504, the CPU 201 notifies the communication apparatus 102 of plan information indicating contents of a plan contracted by the user corresponding to the user identification information received in S501. The communication apparatus 102 displays the received plan information on a display unit of the communication apparatus 102. In this embodiment, as described above, the plurality of plans that are different in the upper limit number of print pages are provided, and the user can change the plan according to a change in consumption behavior. For example, the user can use a plan of which the upper limit number of print pages is large in a busy month, and can change the plan to a plan of which the upper limit number of print pages is small after the busy month. When receiving an instruction to change to another plan from the user, the communication apparatus 102 transmits a plan change request notification for requesting a change to another plan to the management server 103. The plan change request notification includes, for example, the user identification information received in S501, information indicating the type of the other plan, and information indicating the upper limit number of print pages corresponding to the other plan.

The CPU 201 receives a plan change request notification from the communication apparatus 102 via the network I/F 204 (S505). Next, the CPU 201 sets the upper limit number of print pages included in the plan change request notification in the upper limit number of print pages 424 in the apparatus data 440 (S506). The updated apparatus data 440 is stored in the HDD 203. Thereafter, the plan change process is terminated.

FIG. 6 is a flowchart illustrating a procedure of a consumable product order process executed by the management server 103 in FIG. 1. The consumable product order process in FIG. 6 is achieved by the CPU 201 executing the control program stored in the HDD 203. The consumable product order process in FIG. 6 is executed, for example, when the management server 103 receives the plan change request notification from the communication apparatus 102. In this case, the management server 103 specifies the apparatus data as a processing target from among the plurality of sets of apparatus data stored in the HDD 203 based on the user identification information included in the plan change request notification. In this embodiment, a case where the apparatus data about the image forming apparatus 101 is specified as the processing target from among the plurality of sets of apparatus data stored in the HDD 203 will be described as an example.

In FIG. 6, the CPU 201 first reads the apparatus data 440 specified as the processing target from the HDD 203 (S601), and develops the read apparatus data 440 onto the RAM 202. Next, the CPU 201 specifies one of the consumable product data 430a, the consumable product data 430b, . . . included in the apparatus data 440. For example, the consumable product data 430a is specified. Next, the CPU 201 obtains the consumption degree 432a from the specified consumable product data 430a (S602).

Next, the CPU 201 determines whether the obtained consumption degree 432a reaches the order-required level corresponding to the consumable product ID 431a in the consumable product data 430a (S603). For example, when the consumption degree 432a is 80% and the order-required level is 70%, it is determined that the obtained consumption degree 432a reaches the order-required level. In this case, the consumable product order process proceeds to S610 described below. In the meantime, when the consumption degree 432a is 50% and the order-required level is 70%, it is determined that the obtained consumption degree 432a does not reach the order-required level. In this case, the consumable product order process proceeds to S604.

In S604, the CPU 201 calculates a use period of the consumable product corresponding to the consumable product data 430a on the basis of the consumable product use start date 433a of the consumable data 430a and the current date. Next, the CPU 201 obtains the number of pages printed within the use period calculated in S604 (hereinafter referred to as “the number of printed pages in the use period”) from the image forming apparatus 101 corresponding to the serial number 422 in the apparatus data 440 read in S601 (S605).

Next, the CPU 201 calculates a consumption rate of the consumable product corresponding to the consumable product data 430a on the basis of the number of printed pages in the use period obtained in S605 and the consumption degree 432a obtained in S602 (S606). The consumption rate indicates a change of the consumption degree of the consumable product per one print page. For example, when the number of print pages on the consumable product use start date 433a is 2000 and the number of printed pages in the use period is 1000, the consumption degree 432a is calculated as 50%. In this case, the consumption rate is 50%/1000 pages=0.05%/page. In addition, when toner in a toner cartridge is full on the consumable product use start date 433a and the consumption degree 432a is 50% in a case where the number of printed pages in the use period is 1000, a consumption rate of the toner cartridge is 50%/1000 pages=0.05%/page.

Next, the CPU 201 calculates in S607 a predicted consumption degree of the consumable product corresponding to the consumable product data 430a on the basis of the consumption rate calculated in S606 and the upper limit number of print pages 424 in the apparatus data 440 read in S601. The predicted consumption degree is a predicted value of the consumption degree of the consumable product corresponding to the consumable product data 430a when printing up to the upper limit number of print pages. As described above, the upper limit number of print pages 424 is the upper limit number of pages that can be printed by the image forming apparatus 101 without paying an additional fee in the plan contracted by the user.

For example, when the consumption rate is 0.05%/page and the remaining number of pages to the upper limit number of print pages 424 is 500 pages, it is expected that the consumption degree increases by 0.05%/page×500 pages=25% when printing up to the upper limit number of print pages. The predicted consumption degree is calculated by adding 25% to the current consumption degree 432a. For example, when the current consumption degree is 50%, the predicted consumption degree is calculated as 75%. In the meantime, when the consumption rate is 0.05%/page and the remaining number of pages to the upper limit number of print pages 424 is 300 pages, it is expected that the consumption degree increases by 0.05%/page×300 pages=15% when printing up to the upper limit number of print pages. The predicted consumption degree is calculated as 65% by adding 15% to 50% that is the consumption degree 432a. As described above, in this embodiment, the predicted consumption degree of the consumable product of the image forming apparatus 101 is calculated based on the plan contracted by the user.

Next, the CPU 201 determines whether the predicted consumption degree calculated in S607 reaches the order-required level corresponding to the consumable product ID 431a in the consumable product data 430a (S608). For example, when the predicted consumption degree calculated in S607 is 65% and the order-required level is 70%, it is determined in S608 that the predicted consumption degree calculated in S607 does not reach the order-required level. In this case, the consumable product order process proceeds to S609.

In S609, the CPU 201 determines whether all the sets of consumable product data in the apparatus data 440 have been checked. When it is determined in S609 that any of the consumable product data included in the apparatus data 440 has not been checked, the CPU 201 specifies the next data, for example, the consumable product data 430b, from the remaining consumable product data included in the apparatus data 440. The consumable product order process then returns to S602. In this way, in this embodiment, it is determined whether the consumption degrees have reached the order-required levels for all the consumable products provided in the image forming apparatus 101. When it is determined in S609 that all the sets of consumable product data included in the apparatus data 440 have been checked, the consumable product order process is terminated.

In S608, for example, when the predicted consumption degree calculated in S607 is 75% and the order-required level is 70%, it is determined that the predicted consumption degree calculated in S607 has reached the order-required level. In this case, the consumable product order process proceeds to S610. As described above, when it is determined in S603 that the obtained consumption degree 432a has reached the order-required level, the consumable product order process also proceeds to S610.

In S610, the CPU 201 controls to ship the consumable product corresponding to the consumable product data 430a. Specifically, the CPU 201 notifies the order server 104 of the consumable product ID 431a in the consumable product data 430a. The order server 104 performs a process for sending the consumable product corresponding to the received consumable product ID 431a to the user. When the process in S610 is completed, the consumable product order process is terminated.

According to the above-described embodiment, the consumable product order process in FIG. 6 for shipping the consumable products of the image forming apparatus 101 is executed. In the consumable product order process in FIG. 6 described above, for example, the predicted consumption degree of the consumable product corresponding to the consumable product data 430a in the apparatus data 440 is calculated on the basis of the plan contracted by the user. When the predicted consumption degree reaches the order-required level (a predetermined value set in advance) corresponding to the consumable product ID 431a of the consumable product data 430a, the control to ship the consumable product corresponding to the consumable product data 430a is performed. That is, a predicted consumption amount is calculated in consideration of the consumption behavior of the user assumed from the plan contracted by the user. This can suppress a decrease in the calculation accuracy of the predicted consumption degree, and thus the consumable product can be shipped at an appropriate timing.

In the above-described embodiment, the predicted consumption degree is calculated based on the upper limit number of print pages corresponding to the plan contracted by the user and the consumption rate indicating the change of the consumption degree of the consumable product per one print page. Thus, the predicted consumption degree indicating the predicted value of the consumption degree of the consumable product when printing up to the upper limit number of print pages corresponding to the plan contracted by the user can be calculated.

In the above-described embodiment, the consumable product order process in FIG. 6 is executed in response to the reception of the plan change request notification. Accordingly, the predicted consumption amount can be calculated in consideration of a change in the consumption behavior of the user assumed from the change in the plan, and thus, a decrease in the calculation accuracy of the predicted consumption degree due to the change in the consumption behavior of the user can be suppressed.

In this embodiment, the timing of executing the consumable product order process in FIG. 6 described above is not limited to the timing of receiving the plan change request notification. For example, the consumable product order process in FIG. 6 may be executed when the management server 103 receives an instruction to execute the consumable product order process in FIG. 6 from the user. In this case, the management server 103 specifies the apparatus data as the processing target from among the plurality of sets of apparatus data stored in the HDD 203 on the basis of the user identification information designated by the user and then starts the process from S601. By executing the consumable product order process in FIG. 6 according to the instruction from the user, the consumable product can be shipped at the timing intended by the user.

In this embodiment, the consumable product order process in FIG. 6 described above may be periodically executed at a predetermined interval. In this case, the management server 103 specifies one set of apparatus data as a processing target from among the plurality of sets of apparatus data stored in the HDD 203 and then starts the process from S601. When completing the execution of the consumable product order process in FIG. 6 described above using the specified apparatus data, the management server 103 specifies the next apparatus data from among the plurality of sets of apparatus data stored in the HDD 203 and executes the consumable product order process in FIG. 6 described above. In this way, the consumable product order process in FIG. 6 is executed for all the sets of apparatus data stored in the HDD 203. By periodically executing the consumable product order process in FIG. 6 at the predetermined interval, it is possible to reduce a situation in which the user cannot use the image forming apparatus 101 due to out of print sheets, toner, or the like.

In the consumable product order process in FIG. 6 described above, the consumable product is not ordered even when the predicted consumption degree has not slightly reached the order-required level. In this case, when the use amount of the consumable product changes due to a slight change in the consumption behavior of the user thereafter, the consumable product may need to be replenished or replaced earlier than predicted. In view of the issue, when the consumable product order process in FIG. 6 is periodically executed, even when the predicted consumption degree does not reach the order-required level but the difference between the predicted consumption degree and the order-required level is not more than a predetermined threshold, the consumable product order process at the next time may be executed at an interval shorter than the predetermined interval. Thus, the consumable product can be shipped at an appropriate timing in response to a slight change in the consumption behavior of the user.

In this embodiment, it is controlled so as to ship the consumable product on the basis of a predicted remaining amount of the consumable product of the image forming apparatus 101 calculated on the basis of the plan contracted by the user. In such a configuration, the image forming apparatus 101 transmits the remaining amount of the consumable product used in the image forming process to the management server 103. In this embodiment, a counter value, such as the number of remaining uses or the number of remaining pages, may be transmitted as the remaining amount of the consumable product. Alternatively, information representing the remaining amount of the consumable product by percentage may be transmitted while the case where the remaining amount of the consumable product is zero is set to 0%. The image forming apparatus 101 periodically transmits the remaining amount of the consumable product to the management server 103. Alternatively, the image forming apparatus 101 transmits the remaining amount of the consumable product to the management server 103 after executing a predetermined event in which the consumable product is used, such as an image forming process, or when receiving a transmission request from the management server 103.

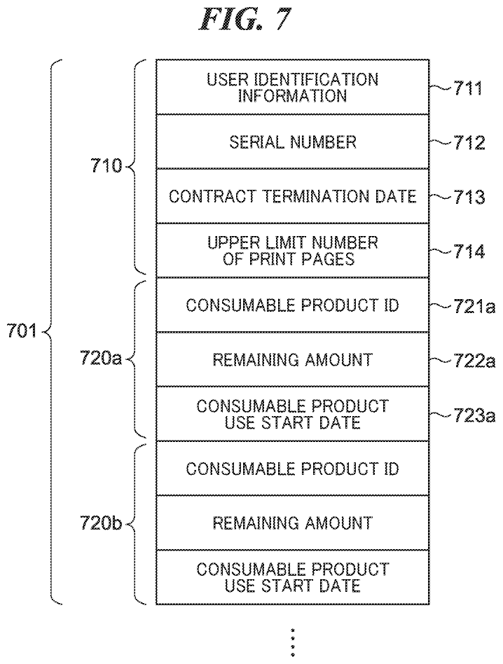

The management server 103 stores apparatus data 701 in FIG. 7 including a remaining amount received from the image forming apparatus 101 in the apparatus data storage area 402 of the HDD 203. The apparatus data 701 is similar to the apparatus data 440, and includes apparatus identification data 710 and a plurality of sets of consumable product data 720a, consumable product data 720b, . . . respectively corresponding to a plurality of consumable products included in the image forming apparatus 101. In FIG. 7, the consumable product data 720a and the consumable product data 720b among n-sets of consumable product data are shown as examples.

The apparatus identification data 710 is data for identifying the image forming apparatus 101, and has the same configuration as the apparatus identification data 420 described above. The consumable product data 720a, the consumable product data 720b, . . . are data relating to the consumable products of the image forming apparatus 101. The consumable product data 720a, the consumable product data 720b, . . . have the same configuration, and the configuration of the consumable product data 720a will be described below as an example.

The consumable product data 720a is configured by a consumable product ID 721a, a remaining amount 722a, and a consumable product use start date 723a. The consumable product ID 721a is the number for identifying the consumable product of the image forming apparatus 101. In this embodiment, as shown in FIG. 4C, the names of consumable products corresponding to the consumable product IDs are managed. In this embodiment, as shown in FIG. 4D, the order-required level indicating the remaining amount of the consumable product that requires replenishment or replacement is defined for each of the consumable product IDs.

The remaining amount 722a is information representing the remaining amount of the consumable product in percentage when an amount of an unused consumable product corresponding to the consumable product data 720a is 100% and the remaining amount when the remaining amount is zero is 0%. For example, when the consumable product corresponding to the consumable product data 720a is a print sheet, the remaining amount 722a is information indicating a ratio of the remaining number of pages to the maximum number of stacked print sheets in percentage. When the consumable product corresponding to the consumable product data 720a is a replacement part, such as a toner cartridge or an ink cartridge, the remaining amount 722a is information indicating a ratio of the remaining amount to the unused amount of the toner or ink in percentage. The remaining amount 722a may not be information expressed by the percentage described above as long as the information reveals the current remaining amount.

The consumable product use start date 723a is a date on which the use of the consumable product corresponding to the consumable product data 720a is started.

FIG. 8 is a flowchart illustrating another procedure of the consumable product order process in FIG. 6. The consumable product order process in FIG. 8 is similar to the consumable product order process in FIG. 6 described above. Hereinafter, contents different from those of the consumable product order process in FIG. 6 will be described. The consumable product order process in FIG. 8 is also achieved by the CPU 201 executing a control program stored in the HDD 203 as with the consumable product order process in FIG. 6. The consumable product order process in FIG. 8 is also executed when the management server 103 receives the plan change request notification from the communication apparatus 102, or when the management server 103 receives an instruction to execute the consumable product order process from the user, as with the consumable product order process in FIG. 6. The consumable product order process in FIG. 8 may be periodically executed at a predetermined interval. In this embodiment, for example, a case where the apparatus data 701 of the image forming apparatus 101 is specified as a processing target from among a plurality of sets of apparatus data stored in the HDD 203 will be described.

In FIG. 8, the CPU 201 first reads the apparatus data 701 specified as the processing target from the HDD 203 (S801), and deploys the read apparatus data 701 onto the RAM 202. Next, the CPU 201 specifies one of the plurality of sets of consumable product data 720a, consumable product data 720b, . . . included in the apparatus data 701. For example, the consumable product dataset 720a is specified. Next, the CPU 201 obtains the remaining amount 722a from the specified consumable product data 720a (S802).

Next, the CPU 201 determines whether the obtained remaining amount 722a is not more than the order-required level corresponding to the consumable product ID 721a of the consumable product data 720a (S803). For example, when the remaining amount 722a is 10% and the order-required level is 20%, it is determined that the obtained remaining amount 722a is not more than the order-required level. In this case, the consumable product order process proceeds to S810 that is the same process as S610 described above. In the meantime, when the remaining amount 722a is 50% and the order-required level is 20%, it is determined that the obtained remaining amount 722a is more than the order-required level. In this case, the consumable product order process proceeds to S804.

In S804, the CPU 201 calculates the use period of the consumable product corresponding to the consumable product data 720a on the basis of the consumable product use start date 723a of the consumable product data 720a and the current date. Next, the CPU 201 obtains in S805 the number of printed pages in the use period from the image forming apparatus 101 corresponding to the serial number 712 in the apparatus data 701 read in S801. The number of printed pages in the use period is the number of pages printed in the use period calculated in S804.

Next, the CPU 201 calculates in S806 the consumption rate of the consumable product corresponding to the consumable product data 720a on the basis of the number of printed pages in the use period obtained in S805 and the remaining amount 722a obtained in S802. In S806, the consumption rate is calculated by the same method as that in S606 described above.

Next, the CPU 201 calculates in S807 the predicted remaining amount of the consumable product corresponding to the consumable product data 720a on the basis of the consumption rate calculated in S806 and the upper limit number of print pages 714 in the apparatus data 701 read in S801. The predicted remaining amount is a predicted value of the remaining amount of the consumable product corresponding to the consumable product data 720a when printing up to the upper limit number of print pages.

For example, when the consumption rate is 0.05%/page and the remaining number of pages up to the upper limit number of print pages 714 is 500 pages, it is expected that the remaining amount of the consumable product corresponding to the consumable product data 720a is reduced by 0.05%/page×500 pages=25% when printing up to the upper limit number of print pages. For example, when the current remaining amount 722a is 50%, the predicted remaining amount 25% of the consumable product corresponding to the consumable product data 720a is calculated by subtracting 25% from 50%. In the meantime, when the consumption rate is 0.05%/page and the remaining number of pages up to the upper limit number of print pages 714 is 300 pages, it is expected that the remaining amount of the consumable product corresponding to the consumable product data 720a is reduced by 0.05%/page×300 pages=15% when printing up to the upper limit number of print pages. For example, when the current remaining amount 722a is 50%, the predicted remaining amount 35% of the consumable product corresponding to the consumable product data 720a is calculated by subtracting 15% from 50%. As described above, in this embodiment, the predicted remaining amount of the consumable product of the image forming apparatus 101 is calculated on the basis of the plan contracted by the user.

Next, the CPU 201 determines in S808 whether the predicted remaining amount calculated in S807 is not more than the order-required level corresponding to the consumable product ID 721a in the consumable product data 720a. For example, when the predicted remaining amount calculated in S807 is 25% and the order-required level is 20%, it is determined that the predicted remaining amount calculated in S807 is more than the order-required level. In this case, the consumable product order process proceeds to S809.

In S809, the CPU 201 determines whether all the sets of consumable product data in the apparatus data 701 have been checked. When it is determined in S809 that any of the consumable product data included in the apparatus data 701 has not been checked, the CPU 201 specifies the next data, for example, the consumable product data 720b, from the remaining consumable product data included in the apparatus data 701. Thereafter, the consumable product order process returns to S802. When it is determined in S809 that all the sets of consumable product data included in the apparatus data 701 have been checked, the consumable product order process is terminated.

For example, when the predicted remaining amount calculated in S807 is 15% and the order-required level is 20%, it is determined in S808 that the predicted remaining amount calculated in S807 is not more than the order-required level. In this case, the consumable product order process proceeds to S810 that is the same process as S610 described above.

In the above-described embodiment, the consumable product order process in FIG. 8 for shipping the consumable product of the image forming apparatus 101 is executed. In the consumable product order process in FIG. 8, for example, the predicted remaining amount of the consumable product corresponding to the consumable product data 720a of the apparatus data 701 is calculated on the basis of the plan contracted by the user. When the predicted remaining amount is not more than the order-required level corresponding to the consumable product ID 721a of the consumable product data 720a, it is controlled so as to ship the consumable product corresponding to the consumable product data 720a. That is, the predicted remaining amount is calculated in consideration of the consumption behavior of the user assumed from the plan contracted by the user. This can suppress a decrease in the calculation accuracy of the predicted remaining amount, and thus the consumable product can be shipped at an appropriate timing.

In the consumable product order process in FIG. 8 described above, the consumable product is not ordered even when the predicted remaining amount is slightly larger than the order-required level. In this case, when the use amount of the consumable product changes due to a slight change in the consumption behavior of the user, the consumable product may need to be replenished or replaced earlier than predicted. In view of the issue, when the consumable product order process in FIG. 8 is periodically executed, even when the predicted remaining amount is slightly larger than the order-required level but the difference between the predicted remaining amount and the order-required level is not more than a predetermined threshold, the consumable product order process at the next time may be executed at an interval shorter than the predetermined interval. Thus, the consumable product can be shipped at an appropriate timing in response to a slight change in the consumption behavior of the user.

In this embodiment, when the plan change request notification received by the management server 103 from the communication apparatus 102 is a notification for a purpose of increasing the number of print pages, the management server 103 may change the order-required level so as to advance an order timing. The plan change request notification for the purpose of increasing the number of print pages is, for example, a notification for requesting a change from a contracted plan to a plan of a larger upper limit number of print pages than the contracted plan, or a notification for requesting a change from a contracted plan to a plan of a higher print speed than the contracted plan. For example, the order-required level used in the consumable product order process in FIG. 6 described above is changed to a value smaller than that before the plan change. The order-required level used in the consumable product order process in FIG. 8 is changed to a value larger than that before the plan change. By such control, the consumable product can be shipped at an appropriate timing even in a period in which the number of print pages suddenly increases due to a busy season.

In this embodiment, when the plan change request notification received by the management server 103 from the communication apparatus 102 is a notification for a purpose of decreasing the number of print pages, the management server 103 may change the order-required level so as to delay an order timing. The plan change request notification for the purpose of decreasing the number of print pages is, for example, a notification for requesting a change from a contracted plan to a plan of a smaller upper limit number of print pages than the contracted plan, or a notification for requesting a change from a contracted plan to a plan of a lower print speed than the contracted plan. For example, the order-required level used in the consumable product order process in FIG. 6 described above is changed to a value larger than that before the plan change. The order-required level used in the consumable product order process in FIG. 8 is changed to a value smaller than that before the plan change. Such control can avoid a situation in which the consumable product is shipped earlier and is stored for a long time at the user's place in a period in which the number of print pages is suppressed after the busy season.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While various embodiments of the present disclosure have been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-066397, filed Apr. 14, 2023, which is hereby incorporated by reference herein in its entirety.

What is claimed is:

1. An information processing apparatus capable of executing a predetermined process for ordering a consumable product of an image forming apparatus, the information processing apparatus comprising:
one or more processors causes the information processing apparatus to:
calculate a predicted consumption degree of the consumable product based on a contracted plan selected by a user from among plans for using the image forming apparatus in the predetermined process;
determine whether the predicted consumption degree reaches a predetermined value; and
control so as to ship the consumable product to the user in a case where it is determined that the predicted consumption degree reaches the predetermined value.

2. The information processing apparatus according to claim 1, wherein the one or more processors further causes the information processing apparatus to:
obtain a consumption degree of the consumable product;
obtain a number of printed pages in a use period of the consumable product; and
calculate a consumption rate indicating a consumption degree of the consumable product per one print page based on the consumption degree obtained and the number of printed pages obtained,
wherein the predicted consumption degree of the consumable product is calculated based on an upper limit number of print pages corresponding to the contracted plan and the consumption rate in the predetermined process.

3. The information processing apparatus according to claim 1, wherein the predetermined process is executed in response to reception of a request notification requesting a change from the contracted plan to another plan.

4. The information processing apparatus according to claim 3, wherein the predetermined value is decreased in a case where the request notification is a notification for a purpose of increasing the number of print pages.

5. The information processing apparatus according to claim 3, wherein the predetermined value is increased in a case where the request notification is a notification for a purpose of decreasing the number of print pages.

6. The information processing apparatus according to claim 1, wherein the predetermined process is executed at a predetermined interval.

7. The information processing apparatus according to claim 6, wherein the predetermined process at a next time is executed at an interval shorter than the predetermined interval in a case where it is determined that the predicted consumption degree does not reach the predetermined value and a difference between the predicted consumption degree and the predetermined value is not more than a preset threshold.

8. The information processing apparatus according to claim 1, wherein the predetermined process is executed according to an instruction from the user.

9. The information processing apparatus according to claim 1, wherein the consumable product is a print sheet.

10. The information processing apparatus according to claim 1, wherein the consumable product is a toner cartridge.

11. The information processing apparatus according to claim 1, wherein the consumable product is an ink cartridge.

12. An information processing apparatus capable of executing a predetermined process for ordering a consumable product of an image forming apparatus, the information processing apparatus comprising:
one or more processors causes the information processing apparatus to:
calculate a predicted remaining amount of the consumable product based on a contracted plan selected by a user from among plans for using the image forming apparatus in the predetermined process;
determine whether the predicted remaining amount is not more than a predetermined value; and
control so as to ship the consumable product to the user in a case where it is determined that the predicted remaining amount is not more than the predetermined value.

13. The information processing apparatus according to claim 12, wherein the one or more processors further causes the information processing apparatus to: obtain a remaining amount of the consumable product;
obtain a number of printed pages in a use period of the consumable product; and
calculate a consumption rate indicating a consumption degree of the consumable product per one print page based on the remaining amount obtained and the number of print pages obtained,
wherein the predicted remaining amount of the consumable product is calculated based on an upper limit number of print pages corresponding to the contracted plan and the consumption rate in the predetermined process.

14. The information processing apparatus according to claim 12, wherein the predetermined process is executed in response reception of a request notification requesting a change from the contracted plan to another plan.

15. The information processing apparatus according to claim 14, wherein the predetermined value is increased in a case where the request notification is a notification for a purpose of increasing the number of print pages.

16. The information processing apparatus according to claim 14, wherein the predetermined value is decreased in a case where the request notification is a notification for a purpose of decreasing the number of print pages.

17. The information processing apparatus according to claim 12, wherein the predetermined process is periodically executed at a preset interval.

18. The information processing apparatus according to claim 17, wherein the predetermined process at a next time is executed at an interval shorter than the predetermined interval in a case where it is determined that the predicted remaining amount is more than the predetermined value and a difference between the predicted remaining amount and the predetermined value is not more than a preset threshold.

19. The information processing apparatus according to claim 12, wherein the predetermined process is executed according to an instruction from the user.

20. The information processing apparatus according to claim 12, wherein the consumable product is a print sheet.

21. The information processing apparatus according to claim 12, wherein the consumable product is a toner cartridge.

22. The information processing apparatus according to claim 12, wherein the consumable product is an ink cartridge.

23. A control method for an information processing apparatus capable of executing a predetermined process for ordering a consumable product of an image forming apparatus, the control method comprising:
calculating a predicted consumption degree of the consumable product based on a contracted plan selected by a user from among plans for using the image forming apparatus in the predetermined process;
determining whether the predicted consumption degree reaches a preset predetermined value; and
controlling so as to ship the consumable product to the user in a case where it is determined that the predicted consumption degree reaches the predetermined value.

24. A non-transitory computer-readable storage medium storing a control program causing a computer to execute a control method for an information processing apparatus capable of executing a predetermined process for ordering a consumable product of an image forming apparatus, the control method comprising:
calculating a predicted consumption degree of the consumable product based on a contracted plan selected by a user from among plans for using the image forming apparatus in the predetermined process;
determining whether the predicted consumption degree reaches a preset predetermined value; and
controlling so as to ship the consumable product to the user in a case where it is determined that the predicted consumption degree reaches the predetermined value.

25. A control method for an information processing apparatus capable of executing a predetermined process for ordering a consumable product of an image forming apparatus, the control method comprising:
calculating a predicted remaining amount of the consumable product based on a contracted plan selected by a user from among plans for using the image forming apparatus in the predetermined process;
determining whether the predicted remaining amount is not more than a predetermined value; and
controlling so as to ship the consumable product to the user in a case where it is determined that the predicted remaining amount is not more than the predetermined value.

26. A non-transitory computer-readable storage medium storing a control program causing a computer to execute a method for an information processing apparatus capable of executing a predetermined process for ordering a consumable product of an image forming apparatus, the method comprising:
calculating a predicted remaining amount of the consumable product based on a contracted plan selected by a user from among plans for using the image forming apparatus in the predetermined process;
determining whether the predicted remaining amount is not more than a predetermined value; and
controlling so as to ship the consumable product to the user in a case where it is determined that the predicted remaining amount is not more than the predetermined value.
